(19) United States
(12) Patent Application Publication
(10) Pub. No.: US 2008/0185320 A1
(43) Pub. Date: Aug. 7, 2008

(54) System for deodorizing and neutralizing waste-water

(76) Inventor: Kevin Leon Buchanan, Clarksville, TN (US)

Correspondence Address: David D. Winters, Suite 237, 2277-C, Wilma Rudolph Blvd, Clarksville, TN, 37040-5898, US

(21) Appl. No.: 12/011,097

(22) Filed: Jan. 24, 2008

Related U.S. Application Data
(60) Provisional application No. 60/900,007, filed on Feb. 7, 2007.

(51) Int. Cl. B01D 35/14

(52) U.S. Cl. 210/86

(57) ABSTRACT

A system for injecting odor and/or corrosion control chemical(s) into sewage, having provision to maintain substantial constancy in the ratio between odor and/or corrosion control chemical(s), and material entering the wet well.

### CROSS REFERENCE TO RELATED APPLICATIONS

This regular patent application is entitled to benefit of U.S. Provisional Patent Application No. 60/900,007 filed Feb. 7, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sewage treatment, and more specifically to system or device for deodorizing and neutralizing a wet well, and neutralizing downstream sewage conduits.

The collection, treatment, and disposal of sewage has long been provided by most municipalities to well over ninety percent of the population. Such systems generally include networks of conduits running away from sewage generating institutions, houses, businesses, etc., which carry sewage to a series of larger and larger conduits, the last of which usually empties into a collection vessel, generally referred to as a wet well. When the wet well is filled to a predetermined level, a pump is activated which quickly evacuates the wet well and sends the sewage to points of further processing and/or disposal by means of a conduit generally referred to as a force main or gravity main.

These mains may be miles long; therefore, sewage introduced into them may be contained therein for extended time periods long enough for chemical(s) and/or microbial action to produce toxic or corrosive materials, especially hydrogen sulfide acid and/or noxious, odiferous, primarily sulfurous, gasses. At the point where the mains discharge sewage to secondary treatment areas, those odiferous gasses and other harmful corrosives and/or toxins are released with the gasses essentially escaping into the atmosphere where they have occasion to waft over populated areas.

It has therefore long been customary to treat sewage with odor and corrosion control chemical(s) to prevent the formation of such odors and corrosive toxicants as sewage processing facilities are often of necessity positioned near populated areas, and when such odors are generated to excess, those people living near the facility are subjected to unpleasantness and are usually quite strident in complaining. Furthermore, the sewage treatment infrastructure can be seriously damaged by exposure to the hydrogen sulfide acid causing reduced life of said infrastructure and markedly increased repair or replacement costs.

At present, the most common method for injecting odor and corrosion control chemical(s) into the wet well comprises an injection pump operating continuously, which also may be supplemented by an auxiliary pump activated periodically by a timer set to engage the auxiliary pump during times of peak sewage production. Thus, the amount of chemical(s) to be injected into the wet well is determined by a combination of conjectures. In example, how much sewage flows into the wet well during a day, when are the peak periods, what specific times will the wet well be empty, and/or periodicity of emptying and filling during particular intervals.

This method may achieve essentially satisfactory results because the times of filling and emptying of the wet well is highly predictable with the number of times filled for each particular hour being very consistent from day to day. For example, if the wet well is usually filled and emptied five times between the hours of 8:00 am and 9:00 am, which would be a peak period, each day, then the auxiliary pump timer would be set to inject five supplementary doses of chemical(s) between the same hours. However, this method often gives occasion to serious disadvantages as small variances frequently do occur in the times and frequencies of filling and emptying which can cause undesirable results. In example, too many doses might be injected into the wet well causing waste of chemical(s), too few doses might be injected into the wet well allowing corrosive toxicants and odors to develop, or the injection of chemical(s) and emptying of the wet well may become unsynchronized so that chemical(s) is injected not when the wet well is empty but when it is partially or completely full thus reducing the effectiveness of the chemical(s).

Furthermore, a continuously operating injection pump will, of necessity, inject chemical(s) during periods when no sewage is entering the wet well. This is an obvious waste of chemical(s). Also, ideally, the amount of chemical(s) being injected should be an appropriate dose for the sewage entering the wet well. But, sewage inflow rates may vary significantly while the rate of chemical(s) injection may not be varied except manually. Thus, to achieve proper dosage, such a system would have to be monitored 24 hours per day.

Also, the periodicity of filling and emptying during non-peak periods may vary causing inconsistent dosages by the continuously running injection pump potentially causing some batches to be under dosed or some to be over dosed. These create high potential of chemical(s) damage to the system.

Therefore, such variances require that the timer and/or flow rate of the continuous pump be constantly reset with no assurances that such resetting will be effective and/or accomplish the most economical use of chemical(s).

U.S. Pat. Nos. 5,312,594 and 5,792,342, both by Heller et al., seeks to overcome these shortcomings by injecting a given treatment chemical dose into the wet well when it is emptied. Thus the chemical(s) for a given volume of sewage is, ideally, already present in the empty wet well when more sewage flows into the wet well, and such flowing action causes the chemical(s) to be well distributed throughout the volume of sewage.

Heller et al. measures a maximum level of sewage and a minimum level of sewage in the wet well. At the maximum level, a pump is activated which evacuates the sewage from the wet well through a force main. When the minimum level is reached, that is, when the wet well is essentially empty, the evacuation pump is shut off and an injection pump is activated which injects an appropriate dose for the volume of sewage contained between said maximum and minimum levels. This volume is constant and is easily calculated according to mathematical principles well known in the art. Thus, a proper dosage for a particular amount of sewage will be applied with need for conjecture of relevant parameters eliminated.

There are disadvantages to Heller at al., however. In example, at times of non-peak usage, a dose of chemical(s) injected into the wet well might remain in the bottom of the wet well or it may remain in a partially filled wet well for extended periods of time whereupon said chemical(s) will lose potency due to reaction with material not affecting odor or corrosive formation. It also creates a potentially damaging situation for the system itself.

Also, at times of peak usage, the inflow of sewage into the wet well will be substantially constant causing periods when sewage will be inflowing at the same time it is being evacuated. Thus, in such situation inflow of sewage will increase the time needed to empty the wet well while no more chemical(s) is injected because Heller et al. teach injection only at the minimum level. Therefore, the sewage entering at peak usage times will be under dosed.

The instant art overcomes the disadvantages of Heller et al. through an embodiment having means to constantly monitor both wet well volume and the rate of change of said volume from which the flow rate of incoming sewage may easily be determined and an injection pump having a variable dosage capability.

Accordingly, when no sewage is inflowing, the injection pump may be shut down and when sewage is inflowing, the inflow rate may be quickly determined and the injection pump activated and adjusted to inject the proper dosage for the amount of sewage inflowing. In addition, when the evacuation pump is activated while sewage is still inflowing, the outflow rate is determined, in real time, or as an already known constant, so that in combination with the rate of said out flow and the rate of change of volume in the wet well the volume of sewage entering may still be calculated and the proper dosage injected even when sewage is entering and out flowing at the same time.

Flow rate may be determined in most systems simply by determining the rate of contents volume change as determined via a float level or other level sensor. In most systems, any inflow rate is negligible in comparison with the outflow rate produced by an exhaust pump. Therefore in calculating the overall flow rate in such a system, inflow rate may, in some cases, be ignored as relatively insignificant. Additionally, outflow will usually be accomplished by a fixed-rate pump, so that if outflow is determined to be underway, the outflow rate may be automatically known.

However, if necessary, flow-rate sensors may be installed at inflow and outflow points. Further, rate of treatment dosage injection may be measured and controlled, producing even further improved economy.

By thusly providing means to accurately dose sewage as it enters the wet well through constant measurement of changes in wet well volume and, if necessary, measurement of outflow rate plus relevant variation of chemical(s) input, the instant invention improves economy by reducing waste of treatment chemicals, and also by improved corrosion prevention within the subject system, therein advancing the subject art.

### BRIEF SUMMARY OF THE INVENTION

It is an object of the invention to provide for the injection into a sewage wet well of a proper amount of odor, corrosion control, and/or sewage treatment-chemical(s) for a volume of sewage in the proper amounts and at the proper times, thus maximizing odor and corrosive toxicant reduction per unit of chemical(s), minimizing the quantity of chemical(s) needed, and reducing system corrosion.

Another object of the invention is to provide a wet well odor and corrosive toxicant reduction system that requires a minimum of monitoring and/or adjustment.

Yet another object of the invention is to create a chemical treatment system that can determine volume of sewage flowing through a wet well and to appropriately adjust the amount of odor and corrosion control or other sewage treatment-chemical(s) injected as the volume of sewage inflowing varies.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed, system or device for deodorizing a wet well comprising: pumps, sensors, deodorizer, dosage control and logic module, pump/dosage control and logic module interfaces, and sensor/dosage control and logic module interfaces.

### BRIEF DESCRIPTION OF THE DRAWINGS

The drawings constitute a part of the specification and include exemplary embodiments to the invention, which may be embodied in various forms. It is to be understood that in some instances, various aspects of the invention may be shown exaggerated or enlarged to facilitate an understanding of the invention.

FIG. 1 is a side view of one embodiment of the invention.

FIG. 2 is a side view of an alternate embodiment of the invention.

### LIST OF COMPONENTS

10 Chemical(s) reservoir
12 Discrete levels
14 Sewage pressure sensor
16 Sewage level sensor
18 Sewage level sensor
20 Chemical(s) injector pump
22 Chemical(s) input conduit
24 Dosage control and logic module
26 Outlet control
30 Sewage level sensor/dosage control and logic module interface
35 Exhaust pump
40 Sewage inlet
45 Sewage outlet
46 sewage inflow rate sensor
47 sewage outflow rate sensor
48 sewage outflow, or outflow-pump, operation sensor
50 Wet well vessel
55 Sewage
60 Wet well sump
65 Chemical(s)
70 Chemical(s) pump/dosage control and logic module interface
75 Exhaust pump/dosage control and logic module interface
100 Force main
A Particular, discrete sewage level
B Particular, discrete sewage level
C Particular, discrete sewage level
D Particular, discrete sewage level
E Particular, discrete sewage level
F Particular, discrete sewage level

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

We will readily appreciate that the embodiments of the instant art may comprise sensors of types well known in the art whose modes of operation both to acquire data and to transmit data are also well known. In addition, the instant art embodiments may also comprise programmable, pre-programmable and/or re-programmable data receiving, data transmitting, and data processing elements well known in the art which may additionally transmit control signals to sundry elements according to modes of operation also well known in the art. Therefore detailed explanations of how said elements accomplish their stated functions are not given.

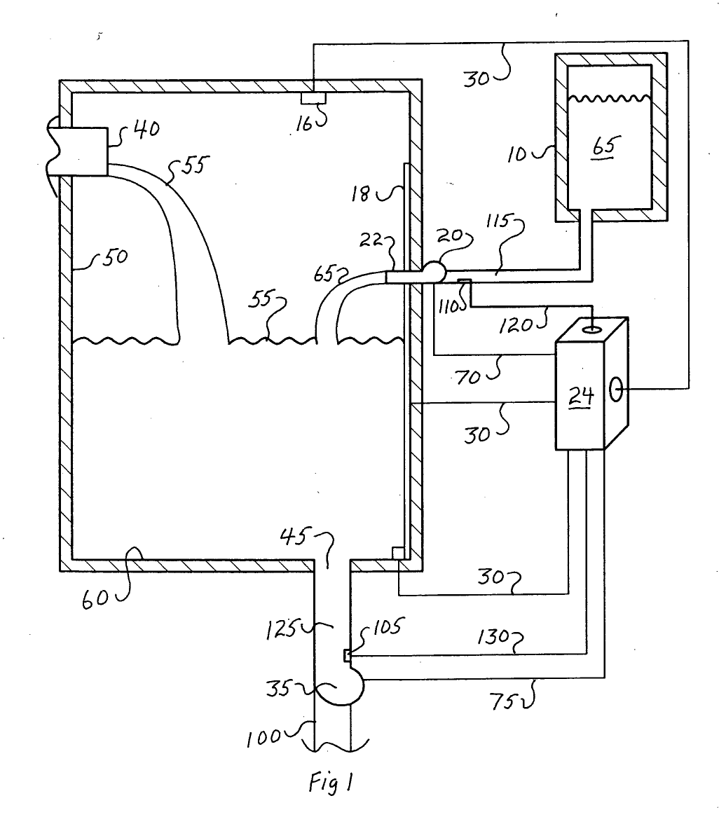

Looking now at FIG. 1, we see a chemical(s) treatment device for a sewage wet well vessel (50) having a sewage inlet (40), a sump (60), and a sewage outlet (45). Associated with the outlet (45) is an exhaust pump (35) which evacuates the wet well (50) through the exhaust pump (35) and out a force main (100). In addition, we note a chemical(s) reservoir (10) containing a sewage treating chemical(s) (65). Communicating with the reservoir (10) is a chemical(s) input conduit (22) having a chemical(s) injector pump (20) which may pump chemical(s) (65) out of the reservoir (10), through the input conduit (22), and into the wet well (50).

Attending again to FIG. 1, we note that sewage (55) enters the wet well (50) and accumulates in the sump (60) and we may readily appreciate that when the sewage (55) reaches a certain volume, the exhaust pump (35) is activated to empty the wet well (50) through the sewage outlet (45) through the exhaust pump (35) and out the force main (100).

Looking yet again at FIG. 1, we see a sewage level sensor (16) of a type which uses sonar, laser, or any of sundry other means well known in the art to ascertain the level of sewage (55) in the wet well (50), a sensor (18) which by sonar, laser or any of sundry means well known in the art measures the depth of the sewage (55) in the wet well (50), and a sensor (14) of a type which ascertains the hydrostatic pressure of sewage (55) at the bottom of the wet well (50) from which pressure data, the depth of the sewage (55) may be determined.

In addition, we note interfaces (30) between the sensors (14, 16, 18, 46, 47 and 48) and a dosage control and logic module (24) so that data regarding the sewage (55) may be transmitted to said module (24).

Now, we may readily appreciate that said sensors (14, 16, 18, 46, 47 and 48) may ascertain and transmit such data very rapidly, up to many times per second, and that by means well known in the art, the dosage control and logic module (24) using input from the sensors (14, 16, 18, 46, 47 and 48) may determine the volume of sewage (55) contained in the wet well (50) at particular times and by comparing successions of said determinations, may ascertain the rate of change of the volume of the sewage (55) and thereby the rate in which sewage (55) is flowing into the wet well (50). Additionally, we may understand that the dosage control and logic module (24) may compute the quantity of sewage (55) entering the wet well (50) utilizing data from any one sensor (14, 16, or 18) so that the others may be eliminated. Also, if a plurality of sensors are employed, the dosage control and logic module may (24), according to pre-determined parameters, choose data from any one sensor (14, 16, or 18) while disregarding the rest or it may average results based on data from all or some of the sensors (14, 16, or 18).

Looking further at FIG. 1, we see a chemical(s) pump/dosage control and logic interface (70) whereby the dosage control and logic module (24) may adjust the amount and/or rate of chemical(s) (65) injected into the wet well (50) by the chemical(s) pump (20). Now, we may readily appreciate that the dosage control and logic module (24) may determine said chemical(s) injection amount and/or rate according to the contents volume and computed rate of sewage flow so that the ratio of sewage inflowing (55) to chemical(s) (65) injected is essentially constant and appropriate to properly treat said sewage (55). Thus, when sewage (55) is entering the wet well (50), chemical(s) (65) sufficient to properly treat said sewage (55) is also being injected into the wet well (50). Likewise, when no sewage (55) is entering the wet well (50), no chemical(s) (65) is being injected into the wet well (50). Thus, only that volume of chemical(s) (65) required to treat the volume, or flowing volume, of sewage (55) in the wet well (50) is ever present in the wet well (50).

Looking yet again at FIG. 1, we note an exhaust pump/dosage control and logic interface (75) whereby the dosage control and logic module (24) may activate, deactivate, and/or control the rate of flow of the exhaust pump (35) and whereby the dosage control and logic module (24) may receive activation data, deactivation data, and or flow rate data from the exhaust pump (35). Now, we may understand that the dosage control and logic module (24) may activate the exhaust pump (35) when the sewage (55) in the wet well (50) reaches a particular level and/or flow rate, and may deactivate the exhaust pump (35) when the sewage (55) in the wet well (50) reaches a particular level and/or flow rate. Thus, the wet well (50) may be filled and emptied successively or cyclically.

In addition, during periods of low usage when the level of sewage (55) in the wet well (50) remains essentially constant due to lack of sewage (55) inflow, the dosage control and logic module (30) may activate the exhaust pump (35) after a specific period of time of essentially no level change. Thus, a quantity of sewage (55) may be prevented from stagnating in the wet well (50), and the wet well (50) may remain essentially empty during periods of non-usage.

Turning attention again to FIG. 1, we may readily appreciate that the exhaust pump (35) may be activated while sewage (55) is flowing into the wet well (50) especially during periods of peak use. In such situation, the sewage flow rate data are transmitted through interface (75) to the dosage control and logic module (24) which combines said data with wet well (50) volume change data and calculates the volume of inflowing sewage (55). Thus, the inflowing sewage (55) may be properly dosed with chemical(s) (65) when sewage (55) is both entering and flowing out of the wet well (50).

Also, we may readily appreciate that any or all parameters according to which the dosage control and logic module (24) initiates any particular action or actions may be changed.

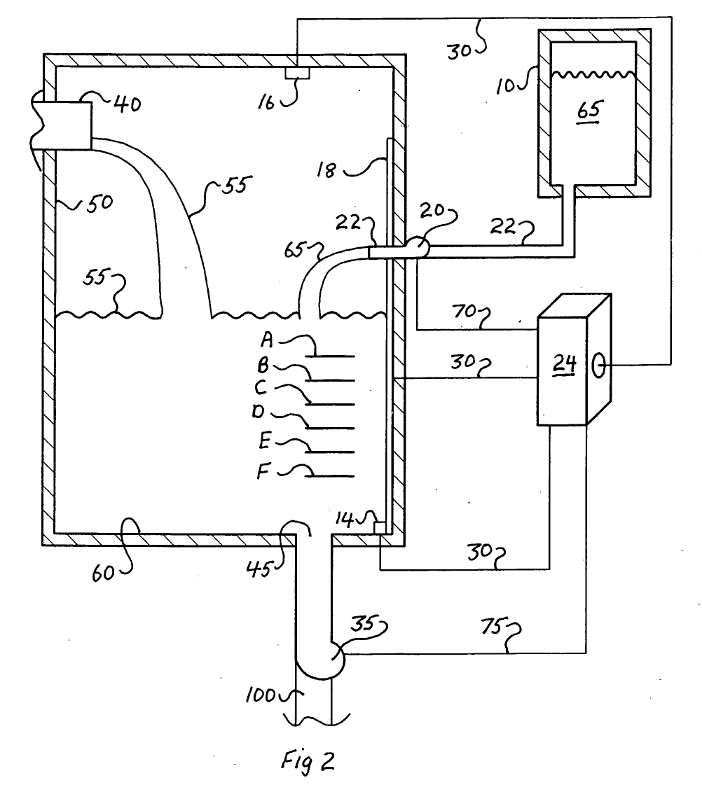

Looking now at FIG. 2, we see a chemical(s) treatment device for a sewage wet well vessel (50) having a sewage inlet (40), a sump (60), and a sewage outlet (45). Associated with the outlet (45) is an exhaust pump (35) which evacuates the wet well (50) through the exhaust pump (35) and out a force main (100). In addition, we note a chemical(s) reservoir (10) containing a sewage treating chemical(s) (65). Communicating with the reservoir (10) is a chemical(s) input conduit (22) having a chemical(s) injector pump (20) which may pump chemical(s) (65) out of the reservoir (10), through the input conduit (22), and into the wet well (50).

Attending again to FIG. 2, we note that sewage (55) enters the wet well (50) and accumulates in the sump (60) and we may readily appreciate that when the sewage (55) reaches a certain volume, the exhaust pump (35) is activated to empty the wet well (50) through the sewage outlet (45) through the exhaust pump (35) and out the force main (100).

Looking yet again at FIG. 2, we see a sewage level sensor (16) of a type which uses sonar, laser, or any of sundry other means well known in the art to ascertain the level of sewage (55) in the wet well (50), a sensor (18) which by sonar, laser or any of sundry means well known in the art measures the depth of the sewage (55) in the wet well (50), and a sensor (14) of a type which ascertains the hydrostatic pressure of sewage (55) at the bottom of the wet well (50) from which pressure data, the depth of the sewage (55) may be determined. In addition, we note interfaces (30) between the sensors (14, 16, and 18) and a dosage control and logic module (24) so that data regarding the sewage (55) may be transmitted to said module (24).

Now we may readily appreciate that the dosage control and logic module (24) may be programmed to administer a dose of chemical(s) (65) not continuously but when the sewage (55) reaches particular, discrete levels. In example, levels represented by letters A, B, C, D, E, or F. Further, we may understand that the dosage control and logic module (24) may compute the volume between said particular, discrete levels and, at a set time inject a proper amount of chemical(s) (65) for said volume. Additionally, said injection of chemical(s) (65) may be proactively timed so that chemical(s) (65) to treat the particular volume of sewage (55) is present in the wet well (50) before, or after, sewage (55) to be treated is present in the wet well (50), or any time there between.

Additionally, we may understand that the dosage control and logic module (24) may ascertain the level of sewage (55) present in the wet well (50) utilizing data from any one sensor (14, 16, or 18) so that the others may be eliminated. Also, if a plurality of sensors are employed, the dosage control and logic module may (24), according to pre-determined parameters, choose data from any one sensor (14, 16, or 18) while disregarding the rest or it may average results based on data from all or some of the sensors (14, 16, or 18).

Looking again at FIG. 2, we may readily appreciate that sewage (55) may enter the wet well (50) at the same time sewage (55) is being pumped out of the wet well (50). Thus the time between the sewage's (55) reaching any particular level may be increased so that the volume of sewage (55) entering the wet well (50) required to raise the level of sewage (55) in the wet well (50) from one point to another will be greater than if no sewage (55) is entering the wet well (50). Further, we may understand that the rate of sewage (55) out flowing may be transmitted to the dosage control and logic module (24) from the exhaust pump (35) through the interface (75) whereupon the dosage control and logic module (24) may ascertain the amount of sewage (55) required to raise the level of sewage (55) in the wet well (50) from one point to another and then adjust the dosage of chemical(s) (65) accordingly.

Therefore, in an embodiment of the instant art, treatment-chemical(s) (65) may be injected into the wet well (50) in doses at particular points and that said doses will be appropriate for the volume of sewage (55) in, or yet to flow into, the wet well (50) whether or not sewage (55) is being evacuated and input to the wet well at the same time. Also, in the same embodiment, the treatment-chemical(s) (65) may be injected into the wet well in individual, discrete doses rather than continuously.

Also, we may readily appreciate that any or all parameters according to which the dosage control and logic module (24) initiates any particular action or actions may be changed.

What is claimed is:

1. A system or device for applying treatment-chemical(s) to the contents of a vessel, comprising;
a container vessel
a container vessel contents level-sensing means;
a container vessel contents level rate of change sensing means;
a container vessel contents inflow;
a container vessel contents outflow;
an outflow control means;
a treatment-chemical(s) reservoir;
a treatment-chemical(s) injection means;
a treatment-chemical(s) injection control means;
a logic unit;
an interface between the logic unit and the container vessel contents level-sensing means;
an interface between the logic unit and the container vessel contents level rate of change sensing means;
an interface between the logic unit and the outflow control means;
an interface between the logic unit and the treatment-chemical(s) injection control means;
a function of the logic unit that receives input from the container contents level-sensing means and upon each occurrence of a predetermined degree of increase in the level of vessel contents, commands the treatment-chemical(s) injection control to inject a predetermined amount of treatment-chemical(s), and that, upon occurrence of each predetermined decrease in the level of vessel contents, resets itself as if to sense a zero increase or decrease state;
a function of the logic unit that receives input from the container contents level-sensing means and upon each occurrence of a predetermined higher level of vessel contents, commands the outflow-pump be begin operation, and upon occurrence of a predetermined lower level of container contents, commands the outflow-pump to cease operation;

2. A system or device for applying treatment-chemical(s) to the contents of a vessel, comprising;
a container vessel
a container vessel contents level-sensing means;
a container vessel contents level rate of change sensing means;
a container vessel contents inflow;
an inflow rate sensing means;
a container vessel contents outflow;
a treatment-chemical(s) reservoir;
a treatment-chemical(s) injection means;
a treatment-chemical(s) injection control means;
a logic unit;
an interface between the logic unit and the container vessel contents level-sensing means;
an interface between the logic unit and the inflow rate sensing means;
an interface between the logic unit and the treatment-chemical(s) injection control means;
a function of the logic unit that receives input from the container contents level-sensing means and inflow rate sensing means, calculates the dosage of treatment chemicals required to maintain a desired concentration of treatment chemicals in the vessel contents, and commands the treatment-chemical(s) injection control means to inject that appropriate dosage of treatment-chemical(s), into the container vessel.

3. A system or device for applying treatment-chemical(s) to the contents of a vessel, comprising;
a container vessel
a container vessel contents level-sensing means;
a container vessel contents level rate of change sensing means;
a container vessel contents inflow;
an inflow rate sensing means;
a container vessel contents outflow;
a treatment-chemical(s) reservoir;
a treatment-chemical(s) injection means;
a treatment-chemical(s) injection control means;
a logic unit;
an interface between the logic unit and the container vessel contents level-sensing means;
an interface between the logic unit and the inflow rate sensing means;
an interface between the logic unit and the treatment-chemical(s) injection control means;
a function of the logic unit that receives input from the container contents outflow rate sensing means and inflow rate sensing means, calculates the dosage of treatment chemicals required to maintain a desired concentration of treatment chemicals in the vessel contents, and commands the treatment-chemical(s) injection control means to inject that appropriate dosage of treatment-chemical(s), into the container vessel.

4. A system or device for applying treatment-chemical(s) to the contents of a vessel, comprising;
a container vessel
a container vessel contents level-sensing means;
a container vessel contents inflow;
a container vessel contents outflow;
a container vessel contents outflow, or outflow-pump, operation sensing means
a treatment-chemical(s) reservoir;
a treatment-chemical(s) injection means;
a treatment-chemical(s) injection control means;
a logic unit;
an interface between the logic unit and the container vessel contents level-sensing means;
an interface between the logic unit and the container vessel contents outflow, or outflow-pump, operation sensing means
an interface between the logic unit and the treatment-chemical(s) injection control means;
a function of the logic unit that receives input from the container contents level sensing means and from the outflow operation sensing means, based on these, calculates the dosage of treatment chemicals required to maintain a desired concentration of treatment chemicals in the vessel contents, and commands the treatment-chemical(s) injection control means to inject that appropriate dosage of treatment-chemical(s), into the container vessel.

5. A system or device for applying treatment-chemical(s) to the contents of a vessel, comprising;
a container vessel
a container vessel contents level-sensing means;
a container vessel contents inflow;
a container vessel contents outflow;
a treatment-chemical(s) reservoir;
a treatment-chemical(s) injection means;
a treatment-chemical(s) injection control means;
a logic unit;
an interface between the logic unit and the container vessel contents level-sensing means;
an interface between the logic unit and the treatment-chemical(s) injection control means;
a function of the logic unit that receives input from the container contents level sensing means, and, based on this, calculates the dosage of treatment chemicals required to maintain a desired concentration of treatment chemicals in the vessel contents, and commands the treatment-chemical(s) injection control means to inject that appropriate dosage of treatment-chemical(s), into the container vessel.
